(19) United States
(12) Patent Application Publication
(10) Pub. No.: US 2006/0234709 A1
(43) Pub. Date: Oct. 19, 2006

(54) System, devices, methods and programs for reducing service interruption during routing area change

(75) Inventors: Iuliana Marinescu, Espoo (FI); Vlora Rexhepi, Espoo (FI); Rami Vaittinen, Singapore (SG); Guillaume Sebire, Espoo (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/392,229

(22) Filed: Mar. 28, 2006

Related U.S. Application Data
(60) Provisional application No. 60/667,209, filed on Mar. 30, 2005.

(51) Int. Cl. H04Q 7/20

(52) U.S. Cl. 455/436

(57) ABSTRACT

Before execution of a routing area update (RAU) procedure associated with a handover of a mobile station (40) from a source cell to a target cell in a mobile telecommunication system, a handover required message (14) is sent to a core network (CN) from a source base station (16) in the source cell having a mobile station identifier (IMSI), an identifier of at least one target cell routing area code (RAC) and a temporary logical link identity (TLLI). In response thereto, a handover command message (32) is sent to the source base station from the core network having a packet-temporary mobile subscriber identity (P-TMSI) for transfer to the mobile station in ciphered form over a radio interface between the source base station and the mobile station so that the mobile station is able to send packet-switched (PS) data on an uplink before the RAU procedure is executed.

### CROSS-REFERENCE TO RELATED APPLICATION

This application claims priority from U.S. Provisional Patent Application number 60/667,209 filed on Mar. 30, 3005.

### BACKGROUND OF THE INVENTION

1. Technical Field

The present invention relates to the evolution of a digital mobile communication system such as the Global System for Mobile Communication (GSM) to a new generation, for instance by way of an enhanced capacity system such as the GSM EDGE Radio Access Network (GERAN) and, more particularly, to enhancing packet-switched services therein by avoiding interruption during handover of a mobile station between cells.

2. Discussion of Related Art

Abbreviations
3GPP Third Generation Partnership Project
BSS Base Station Subsystem
CS Circuit-Switched
DL Downlink
DTM Dual Transfer Mode
EDGE Enhanced Data Rates for GSM Evolution
EGPRS Enhanced GPRS
Gb Interface between an SGSN and a BSS
Gs Interface between an SGSN and an MSC/VLR
GERAN GSM EDGE Radio Access Network
GPRS General Packet Radio Service
GSM Global System for Mobile Communication
Iu Interface between the RNS and the core network.
MS Mobile Station
MSC Mobile Switching Center
NMO Network Mode of Operation
PS Packet-Switched
P-TMSI Packet-TMSI
RAU Routing Area Update
RNS Radio Network Subsystem
SGSN Serving GPRS Support Node
Tdoc Temporary document
TLLI Temporary Logical Link Identity
TMSI Temporary Mobile Subscriber Identity
TS Technical Specification
TSG TS Group
UL Uplink
Um Interface between an MS and the A/Gb mode network.
UMTS Universal Mobile Telecommunications System
VLR Visitor Location Register
WCDMA Wideband Code Division Multiple Access

The Global System for Mobile Communication (GSM) is a second-generation digital system based on the landline Integrated Services Digital Network (ISDN) that improved over an analog, first generation system. A third generation system is in development. As a step halfway toward the deployment of the third generation system an operator may overlay a so-called General Packet Radio Service (GPRS) or “2.5” generation system on the operator's existing second generation deployment. The evolution to the third generation from such a second generation GSM/GPRS deployment is by one or both of two ways. The first is a Wideband Code Division Multiple Access (WCDMA) system that uses a completely different radio interface. The new radio interface of WCDMA (also called UMTS) uses codes to separate users instead of the time slots used by GSM/GPRS. The second is a GSM EDGE (Enhanced Data Rates for GSM Evolution) Radio Access Network (GERAN) system, which builds on the existing GSM time division multiple access architecture. GERAN increases the capacity of both the circuit-switched and the packet-switched resources over the air interface.

As shown in FIG. 1A hereof, 3GPP TS 43.129 shows a reference architecture for PS handover in GERAN A/Gb mode including a Core Network (CN) with an MSC connected to a first SGSN via a Gs interface, the first SGSN connected to a second SGSN and to a GGSN via Gn interfaces, the MSC also connected to a PSTN with the first SGSN connected to other networks via a Gp interface, and with the GGSN connected to other networks via Go and Gi interfaces. For the radio access network, a BSS/GERAN is shown connected to the MSC of the CN via an A interface and to the first SGSN via a Gb interface. The BSS/GERAN includes a BSC connected to BTSs by Abis interfaces. One of the BTSs is shown in communication with an MS via a Um (wireless) interface. The Um interface is the MS to network interface for providing GPRS services over the radio to the MS. An RNS (or another BSS) is also shown with an RNC (or BSC) connected to NodeBs each having cells with Uu interfaces also capable of communicating with the MS. The NodeB is a logical node responsible for radio transmission/reception in one or more cells to/from the User Equipment. User Equipment is the 3G term for a mobile station. The NodeB terminates the Iub interface towards the RNC. The RNC (or BSS) is shown connected to the MSC via an IuCS interface and to the second SGSN via an IuPS interface. The figure shows both user traffic and signalling on most of these interfaces.

In order to enhance the performance of PS services in GERAN A/Gb mode (GPRS, EGPRS) during cell change and in particular during routing area change there is a need to enable minimum service interruption in data transfer. According to the GPRS Service Description in TS 23.060 GPRS, “A/Gb mode” refers to a system or sub-system which operate in A/Gb mode of operation, i.e., with a functional division that is in accordance with the use of an A or a Gb interface between the radio access network and the core network. This definition is consistent with the A/Gb mode definition for the RAN in 3G TS 43.051, “Radio Access Network; Overall description—Stage 2.” Note that A/Gb mode is independent of the support of both interfaces, e.g. an SGSN in A/Gb mode uses only the Gb interface.

A PS Handover for GERAN A/Gb mode procedure is currently being standardized in the TSG GERAN and enables better performance in terms of service interruption for packet-switched services as it allows for uplink and downlink data transfer during a cell/routing area change. One main requirement for this is the enabling of uplink and downlink data transfer during routing area change.

FIG. 1B (from Tdoc GP-031193, Fort Lauderdale, USA, 23-27 Jun. 2003) shows an Inter-SGSN RAU and corresponding UL/DL-data traffic, according to the state of the art. As shown, progress has been made in allowing data traffic on the downlink with little interruption but uplink interruption remains significant.

Minimizing the service interruption when a PS Handover is not available requires enhancement to the Routing Area Update (RAU) procedures in order to allow for uplink data transfer upon successful MS access in the new cell prior to the completion of the RAU procedure.

As pointed out by the assignee hereof in 3GPP TSG GERAN2 #18bis, Phoenix, Ariz., in Tdoc G2-040309 (Agenda Item 5.4.5.2) dated 21-26 Mar. 2004, it is currently defined in 3GPP TS24.008 that: “In GSM, user data transmission in the MS shall be suspended during the routing area updating procedure; user data reception shall be possible. User data transmission in the network may be suspended during the routing area updating procedure.”

This restriction during the RAU procedure is related to the P-TMSI (Packet-Temporary Mobile Subscriber Identity) allocation.

TS 23.003 states that in order to support the subscriber identity confidentiality service the VLRs and SGSNs may allocate Temporary Mobile Subscriber Identities (TMSI) to visiting mobile subscribers. The VLR and SGSNs must be capable of correlating an allocated TMSI with the IMSI of the MS to which it is allocated (a unique International Mobile Subscriber Identity (IMSI) is allocated to each mobile subscriber in the GSM/UMTS system). An MS may be allocated two TMSIs, one for services provided through the MSC, and the other for services provided through the SGSN (P-TMSI for short).

For addressing on resources used for GPRS, a Temporary Logical Link Identity (TLLI) is used. The TLLI to use is built by the MS either on the basis of the P-TMSI (local or foreign TLLI), or directly (random TLLI).

The specification of P-TMSI handling procedures (3GPP TS24.008, 3GPP TS23.060) is applicable in case of RAU, Attach and P-TMSI reallocation procedures (3GPP TS23.060, 3GPP TS24.008) when P-TMSI is assigned for an MS already residing in a cell, but it doesn't cover the handling of the P-TMSI if allocated for an MS before it resides in the cell. While downlink data transfer is allowed, uplink data transfer is not allowed during the RAU procedure. The removal of the restriction from (3GPP TS24.008) on uplink data transfer during PS handover has been discussed in the above-mentioned 3GPP TSG GERAN document Tdoc G2-040309. The restriction on downlink data transfer has been addressed in GP-031193 and NP-030057.

An MS needs a valid P-TMSI assigned by the new SGSN in order to be able to derive a valid TLLI (Temporary Logical Link Identity) for addressing of the radio resources. However during the PS handover it has been identified that even though the P-TMSI is allocated early by the new SGSN, i.e., prior to the RAU procedure, it could not be sent to the MS as the P-TMSI needs to be sent ciphered over the air interface and in GERAN A/Gb mode the layer 2 messages cannot be ciphered.

The problem is how to send the new P-TMSI ciphered through the air interface upon routing area change to the MS with an active PS session and enable uplink data transfer prior to completion of the RAU procedure.

### DISCLOSURE OF INVENTION

This invention proposes a solution to enable the mobile station to continue uplink data transfer upon routing area change prior to the completion of the routing area update procedure.

The solution is that the mobile station receives the new P-TMSI from the new SGSN before the ROUTING AREA UPDATE ACCEPT message is sent. The new P-TMSI has to be sent to the MS ciphered.

In a case when the MS is involved in a dual transfer mode supporting CS and PS services at the same time, the P-TMSI can be sent to the MS through the CS handover signalling under the following conditions:
1. The ciphering is active or is activated in the source cell prior to the beginning of the handover;
2. CS handover signalling, i.e. HANDOVER COMMAND message on the air interface is sent ciphered to the MS
3. NMO I is used, thus there is a Gs interface between the MSC and SGSN.

The manufacturers of MS, BSS, MSC and SGSN and operators would benefit from this invention as it enables better PS service performance for an MS is dual transfer mode.

These and other objects, features and advantages of the present invention will become more apparent in light of the detailed description which follows.

### BRIEF DESCRIPTION OF THE DRAWINGS

FIG. 1A shows the known reference architecture for PS handover in GERAN A/Gb mode.

FIG. 1B shows an Inter-SGSN RAU and corresponding UL/DL-data traffic, according to the state of the art.

FIG. 2 presents the procedure of a P-TMSI transfer between an MSC and a new SGSN.

FIG. 3 presents the procedure of the P-TMSI transfer between the MSC and an MS.

FIG. 4 presents one possible application of the invention during the preparation phase for a DTM handover.

FIG. 5 presents the execution phase of the application of the invention shown in FIG. 4 for a DTM handover.

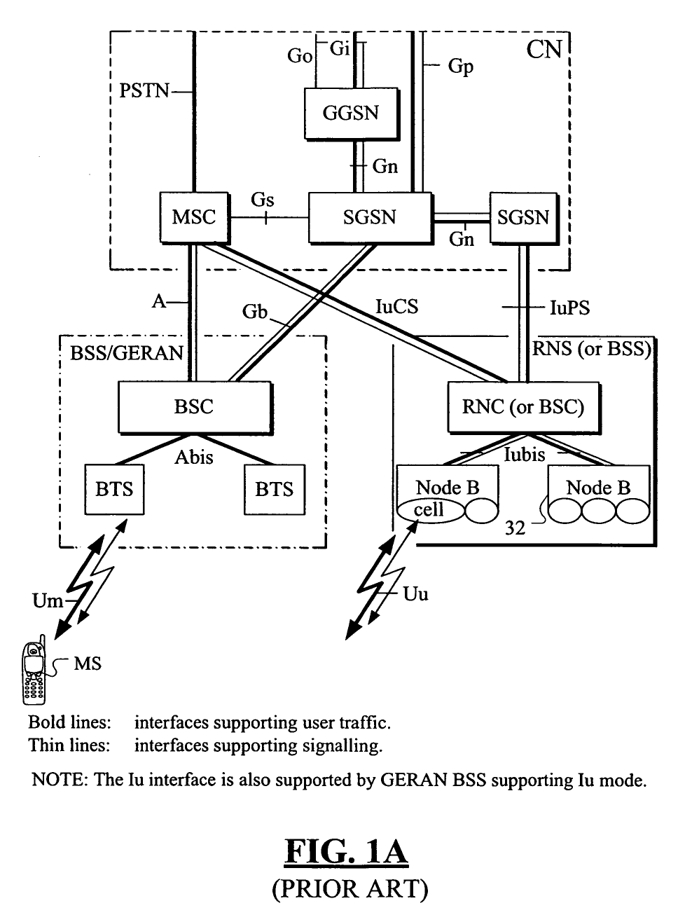

### BEST MODE FOR CARRYING OUT THE INVENTION

Further Abbreviations
BSC Base Station Controller
BTS Base Transceiver Station
CI Cell Identity
CN Core Network
FACCH Fast Associated Control Channel
GGSN Gateway GPRS Support Node
Gn Interface between two GSNs within the same PLMN
IE Information Element
IMSI International Mobile Subscriber Identity
MM Mobility Management
PFC Packet Flow Context
PDP Packet Data Protocol
PLMN Public Land Mobile Network
RAC Routing Area Code
RAI Routing Area Identity
RAN Radio Access Network
RNC Radio Network Controller
TCH Traffic Channel

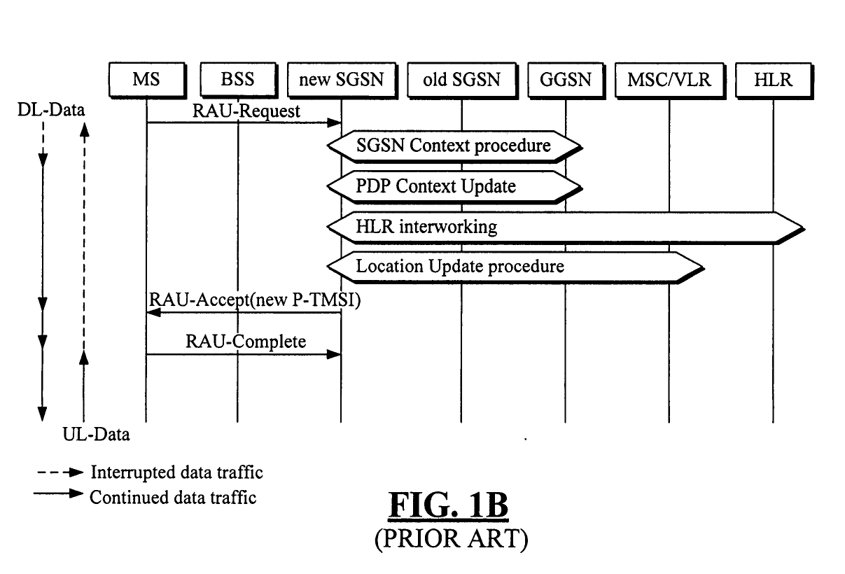

FIG. 2 presents a procedure for a P-TMSI transfer between an MSC 10 and a new SGSN 12. The P-TMSI reallocation procedure is specified in 3GPP TS 24.008 (Mobile radio interface Layer 3 specification; Core network protocols) where paragraph 4.7.6 thereof explains that the P-TMSI is a temporary mobile station identity for GPRS services that is used for identification within the radio interface signalling procedures. The structure of the P-TMSI is specified in 3GPP TS 23.003 (Numbering, addressing and identification). The P-TMSI has significance only within a routing area. Outside the routing area it has to be combined with the routing area identification (RAI) to provide for an unambiguous identity. The purpose of the P-TMSI reallocation procedure is to provide identity confidentiality, i.e. to protect a user against being identified and located by an intruder (see 3GPP TS 42.009 (Security Aspects) and 43.020 (Security-related network functions)). Usually, P-TMSI reallocation is performed at least at each change of a routing area.

The MSC 10 should have an indication when it receives a HANDOVER REQUIRED message on a line 14 from a source BSS 16 that a certain MS has PS resources allocated. These indicators are shown in FIG. 2 on the line 14: IMSI, old TLLI, and old RAC for each target Cell ID listed in a Cell Identifier List IE which should have the RAC associated with it. The RAC information is used by the new SGSN in case of Inter-SGSN scenarios in order to be able to have the old RAI information available. Based on this indication, the MSC can request the new SGSN, provided that a Gs interface is available, to allocate a new P-TMSI for this MS utilizing the Gs interface signalling messages specified in 3GPP TS29.018 (SGSN—VLR; Gs Layer 3). The MSC sends an MS INFORMATION REQUEST message on a line 18 containing the valid IMSI, the old TLLI and a Target Cell ID with the additional RAC information. The value of the target Cell ID equals the value of a Cell Identifier (target) IE, sent by the MSC to a target BSS 19 in a Handover Request message on a line 20. The Target Cell ID and old TLLI are needed by the new SGSN to determine the old SGSN in case of an SGSN change. In case the MSC does not have a Gs interface available with the new SGSN, the new SGSN should request the MS's MM and PDP Contexts by means of SGSN context procedures 22 from the old SGSN in order to be able to allocate the new P-TMSI. If the new SGSN allocates a new P-TMSI, it shall send it to the MSC with an MS INFORMATION RESPONSE message on a line 30 containing the new P-TMSI for the valid IMSI received in the request message on the line 18. It may also be necessary for the new SGSN to execute a PDP Context update procedure 24 with the GGSN.

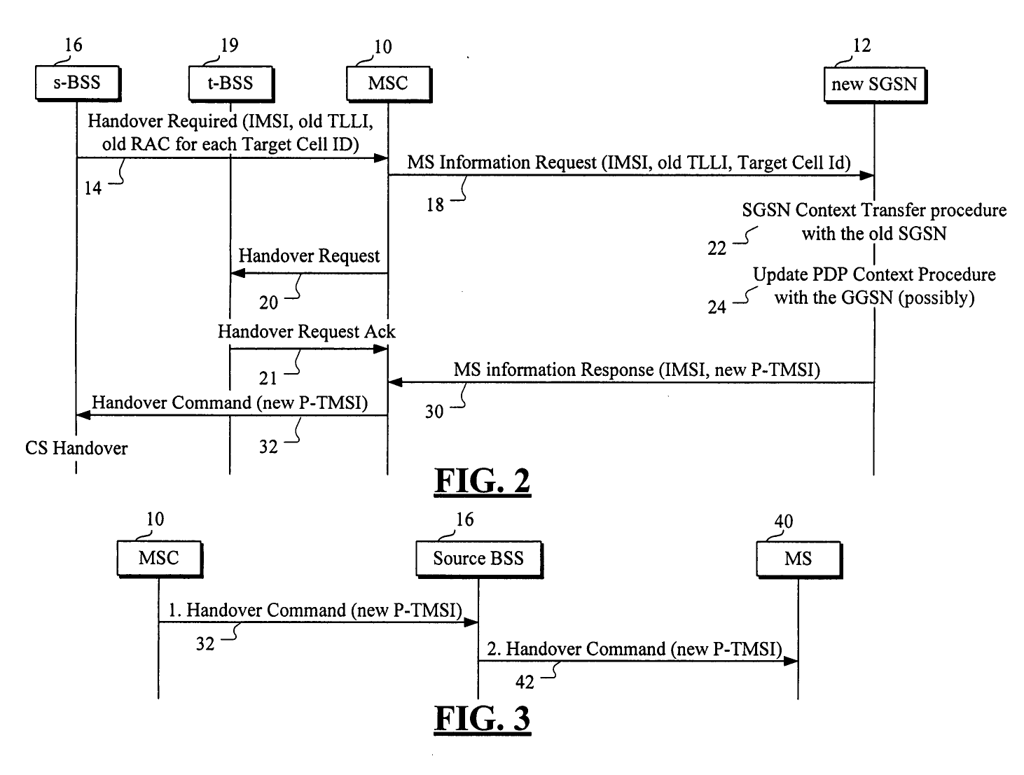

The MSC shall forward the new P-TMSI to the source BSS 16 within a HANDOVER COMMAND message on a line 32. Thereafter, as shown in FIG. 3, this new P-TMSI shall be sent to an MS 40 by the source BSS 16 in a HANDOVER COMMAND message on a line 42 provided this message is ciphered. Upon reception of the HANDOVER COMMAND message on the line 42 containing the new P-TMSI, the MS shall derive or determine the TLLI from this new P-TMSI and can therefore continue with the uplink data transfer prior to the completion of the Routing Area Update procedure (which follows later as described below) provided that there are radio resources available.

In case of a SGSN change, the Gn interface signalling to fetch the PDP and MM Context from the old SGSN may take a long time. This however should not impact the performance of the CS handover procedure. If the MSC has not received the new P-TMSI by the time it is ready to send the HANDOVER COMMA message on the line 32, the MSC shall anyway send the HANDOVER COMMAND message and not delay the handover of the CS resources. The MS 40 in this case will behave, as is the current case when there are no enhancements to RAU procedures, as defined in TS 43.055 (GSM/EDGE RAN; Dual Transfer Mode).

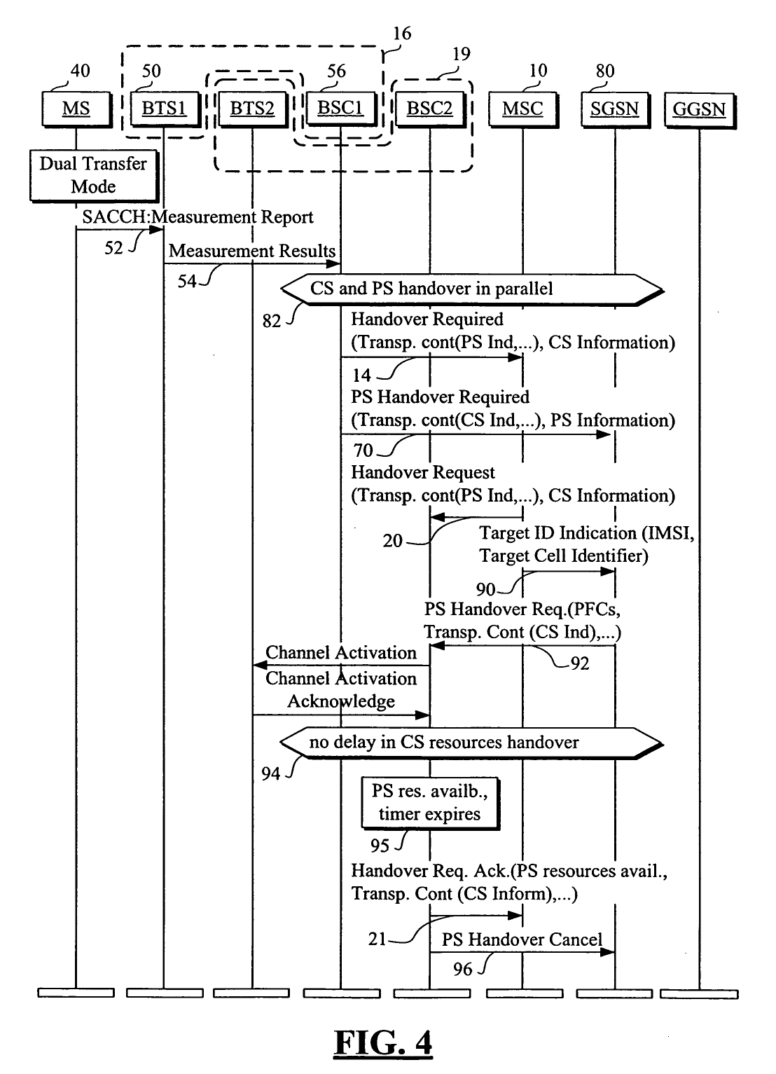

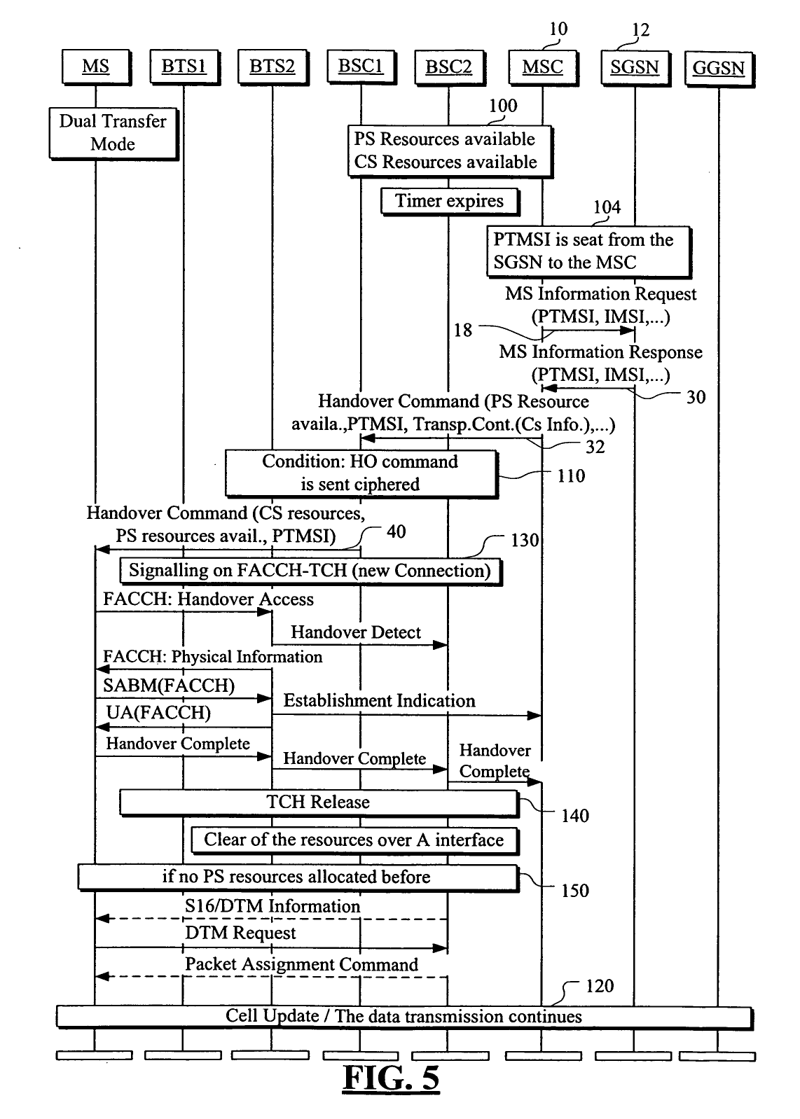

One possible application of the invention is depicted in the example given in FIG. 4 and 5 which shows a case where the MS is in dual transfer mode (DTM) supporting CS and PS services at the same time. In such a case, the P-TMSI can be sent to the MS through the CS handover signalling under the following conditions:
1. The ciphering is active or is activated in the source cell prior to the beginning of the handover;
2. CS handover signalling, i.e. HANDOVER COMMAND message on the air interface is sent ciphered to the MS; and
3. NMO I is used, thus there is a Gs interface between the MSC and the SGSN.

As mentioned above, the solution according to the present invention is that the MS receives the new P-TMSI from the new SGSN before the ROUTING AREA UPDATE ACCEPT message is sent. The above example, where a new ciphered P-TMSI has been sent to the MS 40, will now be shown in FIGS. 4 and 5 integrated within an example of a handover of an MS in DTM.

An alternative to the solution would have been that the new P-TMSI is sent by the MSC first to the target BSS and then the target BSS would have included it in a transparent container to the Source BSS. However in this case there is a risk that the handover procedure would be delayed as it is very likely that the new P-TMSI will not be available at the MSC fast enough such that it could be included in the HANDOVER REQUEST message on the line 20 of FIG. 2.

Referring now to FIG. 4, a BTS 50 is responsive to measurement report signals on a line 52 received from the MS 40 in DTM indicative of radio conditions in neighboring cells. The BTS 50 provides the measurement results in a message on a line 54 to a BSC 56 to which it is connected and which together form the s-BSS of FIG. 2. The measurement results are received by a receiver within the BSC 56 and processed. A list of cells may then be selected according to the prior art. On the other hand a selector within the BTS 50 may select the target cell ID for the CS and PS domain based on the neighboring cell measurement reports received from the receiver. In that case, the selector provides the target cell ID to a transmitter for transmission in the Handover Required message on the line 14 (see FIG. 2) to the MSC 10.

The latter approach is disclosed in a co-owned provisional patent application Serial Number (Atty. Docket 944-003.297) entitled “Combined handover of the Circuit-Switched (CS) and Packet-Switched(PS) resources,” filed on even date herewith. In that case, the source BSS 16 is mandated to send only one cell target ID information in the Cell Identifier List IE in the HANDOVER REQUIRED message on the line 14 to the MSC 10 and the same target cell ID information is sent within a Target Cell ID IE in a PS HANDOVER REQUIRED message on a line 70 to the old SGSN 80 (which then forwards it to the new SGSN 12). In that approach, the MSC 10 and new SGSN 12 will be mandated to choose the selected target cell ID for the handover of CS and PS resources. The co-pending application also shows the CS and PS signaling in the preparation phase being carried out in a parallel process 82, as shown also in FIG. 4 hereof, with the signals on the lines 14 and 70 being sent separately. It should be realized, however, that the solution according to the co-pending application need not be adopted here, in relation to the present invention, and other solutions are possible, including but not limited to a simultaneous signalling solution, as also shown as another embodiment in the co-pending application.

The parallel embodiment of the co-pending application that is shown in FIG. 4 provides synchronization of the handover PS and the CS resources in the source BSS 16 and in the target BSS 19. The mechanism of synchronizing the handover of the PS and CS resources in the DTM applies to both CS and PS handover procedures. This mechanism is supported by the following functions:
resource indications on the CS and PS handover signalling to indicate to target cell network nodes that the CS and PS handover is ongoing at the same time for the same MS;
allocated resource indications on the CS and PS handover signalling to indicate to the source cell nodes that there are CS and PS resources available in the target cell;
management of the synchronization of the CS and PS handover in the source and target cell.

A Target ID Indication message is sent from the MSC 10 on a line 90 to the old SGSN 80 with the IMSI and Target Cell Identifier so that the PFCs may be sent in a PS Handover Request message on a line 92 to the target BSS 19 along with other information including a CS Indication in a Transparent Container. A channel is then prepared for activation within the target BSS 19 followed by a Handover Request Acknowledge message on the line 21 indicating that PS resources are available and other information such as CS information in a transparent container sent to the old SGSN 80. As shown generally 94, there is a timer 95 in the target BSS that ensures the CS resources are not delayed in case the PS handover setup takes too long. In that case, a PS Handover Cancel message is sent on a line 96 from the target BSS 19 to the old SGSN 80 and the CS handover is allowed to proceed without a parallel PS handover.

Assuming the PS resources were made known before the timer expired, as shown at 100 in FIG. 5, the MS Information Request message on the line 18 is then sent from the MSC 10 to the new SGSN 12 (see also FIG. 2 and the accompanying description). The new SGSN responds with the MS Information Response message on the line 30 to the MSC and the MSC then sends the Handover Command message on the line 32 to the source BSS 16 which then sends a similar Handover Command message on the line 42 to the MS 40. Note that the Handover Command message on the line 40 is ciphered over the air interface, as indicated by a condition 110.

Note that the HO Command message on the line 40, according to the present invention, is carried out before a cell update procedure 120 shown at the bottom of FIG. 5. In fact, several additional procedures may be carried out before the cell update including signalling on FACCH-TCH (new Connection) 130 and TCH Release 140. Also shown is a procedure 150 which may be carried out in case the PS Handover had to be cancelled (see FIG. 4) in which case a PS channel may now be established.

Thus the objects of the present invention have been accomplished by the above teachings but it should be realized that only an example of how to carry it out has been disclosed in detail and these details should not be construed as limiting the present invention thereto but rather the following claims are provided to set forth the proper scope of the invention.

1. Method for execution by a source base station in a mobile communications system prior to execution of a routing area update (RAU) procedure, comprising the steps of:
sending to a core network a handover required message (14) having a mobile station identifier (IMSI), an identifier of at least one target cell routing area code (RAC) and a temporary logical link identity (TLLI), and
receiving a handover command message (32) from said core network having a new temporary mobile subscriber identity (P-TMSI) for accessing services provided through a serving support node (12) of the core network.

2. The method of claim 1, further comprising the step of
sending a ciphered handover command message (42) from said source base station to a mobile station (40) having said new temporary mobile subscriber identity (P-TMSI) for use by said mobile station in determining a temporary logical link identity for addressing resources of said core network so that said mobile station is able to send packet-switched data on an uplink during said RAU procedure.

3. Computer program stored on a computer readable medium for executing the steps of claim 1.

4. Base station (16), comprising:
means for sending to a core network a handover required message (14) having a mobile station identifier (IMSI), an identifier of at least one target cell routing area code (RAC) and a temporary logical link identity (TLLI); and
means for receiving a handover command message (32) from said core network having a new temporary mobile subscriber identity (P-TMSI) for packet-switched (PS) services provided through a serving support node (12) of the core network for enabling a mobile station to determine a temporary logical link identity for addressing resources of said core network so that said mobile station is able to send PS data on an uplink before a routing area update (RAU) procedure is completed.

5. The base station of claim 4, further comprising means for sending a ciphered handover command message (42) from said apparatus to said mobile station having said new temporary mobile subscriber identity (P-TMSI).

6. Method for execution in a core network (CN) of a mobile communications system prior to execution of a routing area update (RAU) procedure associated with a handover of a mobile station from a source cell to a target cell, comprising the steps of:
receiving from a source base station (16) in said source cell a handover required message (14) having a temporary logical link identity (TLLI), a mobile station identifier (IMSI), and an identifier of at least one target cell (RAC), and
sending to said source base station a handover command message (32) having a new packet-temporary mobile subscriber identity (P-TMSI) for transfer to said mobile station in ciphered form over a radio interface between said source base station and said mobile station so that said mobile station is able to send PS data on an uplink before said RAU procedure is completed.

7. The method of claim 6, wherein said new packet-temporary mobile subscriber identity (P-TMSI) deciphered by said mobile station is for use in determining a temporary logical link identity for said mobile station to use in accessing packet-switched services of a support node (12) of the core network serving the target cell.

8. The method of claim 6, further comprising the step of
executing, before said step of sending, a context transfer procedure between a support node (12) of the core network serving the target cell and a support node serving the source cell.

9. The method of claim 8, further comprising the step of executing an update context procedure with a gateway support node (GGSN).

10. Computer program stored on a computer readable medium for executing the steps of claim 6.

11. Core network (CN) of a mobile communications system having a source base station in a source cell handing over a mobile station in said source cell to a target cell, comprising:
means for receiving from said source base station (16) in said source cell a handover required message (14) having a temporary logical link identity (TLLI), a mobile station identifier (IMSI), and an identifier (RAC) of at least one target cell; and
means for sending to said source base station a handover command message (32) having a new packet-temporary mobile subscriber identity (P-TMSI) for transfer to said mobile station in ciphered form over a radio interface between said source base station and said mobile station so that said mobile station is able to send packet-switched data on uplink before execution of a routing area update (RAU) procedure associated with said handing over of said mobile station.

12. The core network of claim 11, wherein said new packet-temporary mobile subscriber identity (P-TMSI) deciphered by said mobile station is for use in determining a temporary logical link identity for said mobile station to use in accessing packet-switched services of a support node (12) of the core network serving the target cell.

13. The core network of claim 11, further comprising means for executing a context transfer procedure between a support node (12) of the core network serving the target cell and a support node serving the source cell.

14. The core network of claim 13, further comprising means for executing an update context procedure with a gateway support node (GGSN).

15. Method for execution in a mobile switching center (10) of a core network (CN) of a mobile communication system prior to execution of a routing area update (RAU) procedure associated with a handover of a mobile station from a source cell to a target cell, comprising the steps of:
receiving from a source base station (16) in said source cell a handover required message (14) having a temporary logical link identity (TLLI), a mobile station identifier (IMSI), and an identifier of at least one target cell (RAC), and
sending a mobile station (MS) information request message (18) to a serving support node (12) of said target cell having said TLLI, said IMSI and said RAC,
receiving an MS information response message (30) from said serving support node of said target cell having a new packet-temporary mobile subscriber identity (P-TMSI), and
sending a handover command message (32) to said source base station having said P-TMSI for transfer to said mobile station in ciphered form over a radio interface between said source base station and said mobile station.

16. The method of claim 15, wherein said new packet-temporary mobile subscriber identity (P-TMSI) deciphered by said mobile station is for use in determining a temporary logical link identity for said mobile station to use in accessing packet-switched services of a support node (12) of the core network serving the target cell so that said mobile station is able to send packet-switched data on an uplink.

17. The method of claim 15, further comprising the step of executing, before said step of sending, a context transfer procedure between a support node (12) of said core network serving the target cell and a support node serving the source cell.

18. The method of claim 17, further comprising the step of executing an update context procedure with a gateway support node (GGSN).

19. Computer program stored on a computer readable medium for executing the steps of claim 15.

20. Mobile switching center (10) of a core network (CN) of a mobile communications system able to handover a mobile station from a source cell to a target cell using a routing area update procedure (RAU), comprising:
means for receiving from a source base station (16) in said source cell a handover required message (14) having a temporary logical link identity (TLLI), a mobile station identifier (IMSI), and an identifier of at least one target cell (RAC), and
means for sending a mobile station (MS) information request message (18) to a serving support node (12) of said target cell having said TLLI, said IMSI and said RAC,
means for receiving an MS information response message (30) from said serving support node of said target cell having a new packet-temporary mobile subscriber identity (P-TMSI), and
means for sending a handover command message (32) to said source base station having said P-TMSI for transfer to said mobile station in ciphered form over a radio interface between said source base station and said mobile station.

21. The mobile switching center (10) of claim 20, wherein said new packet-temporary mobile subscriber identity (P-TMSI) deciphered by said mobile station is for use in determining a temporary logical link identity for said mobile station to use in accessing packet-switched services of a support node (12) of the core network serving the target cell so that said mobile station is able to send packet-switched data on an uplink.

22. The mobile switching center (10) of claim 20, further comprising means (22) for executing, before said step of sending, a context transfer procedure between a support node (12) of said core network serving the target cell and a support node serving the source cell.

23. The mobile switching center (10) of claim 20, further comprising means (24) for executing an update context procedure with a gateway support node (GGSN).

24. Method for execution in a mobile station (40) in a source cell for utilizing both circuit-switched (CS) and packet-switched (PS) resources of a core network via radio link between said mobile station and a source base station in said source cell, said mobile station able to move to a target cell for utilizing said CS and PS resources via a radio link between said mobile station and a target base station, comprising the steps of:
sending a measurement report to said source base station having radio information concerning said source cell and said target cell, and
receiving a ciphered handover command from said source base station of said core network having a new temporary mobile subscriber identity (P-TMSI) from which a temporary logical link identity is derivable for use in said mobile station addressing said PS resources of the core network from a node (12) of said core network serving said target cell before a routing area update procedure is carried out.

25. Computer program stored on a computer readable medium for executing the steps of claim 24 in said mobile station.

26. Mobile station (40) for utilizing both circuit-switched (CS) and packet-switched (PS) resources of a core network via a radio link between said mobile station and a source base station in a source cell, said mobile station able to move to a target cell for utilizing said CS and PS resources via a radio link between said mobile station and a target base station, comprising:
means for sending a measurement report to said source base station having radio information concerning said source cell and said target cell, and
means for receiving a ciphered handover command from said source base station of said core network having a new temporary mobile subscriber identity (P-TMSI) from which a temporary logical link identity is derivable for use in said mobile station addressing said PS resources of the core network from a node (12) of said core network serving said target cell before a routing area update procedure is carried out.

27. Method for execution by a serving support node (12) of a mobile telecommunication network prior to a handover of a mobile station (MS) from a source cell to a target cell, comprising the steps of:
receiving an MS information request message (18) from a mobile switching center (10) having an MS identifier (IMSI), an identifier of said target cell, and a temporary logical link identity (TLLI), and
sending, in response to said MS information request message, an MS information response message (30) having a new temporary mobile subscriber identity (P-TMSI) for use in accessing packet-switched (PS) services provided by said serving support node before execution of a routing area update (RAU) procedure so that said MS is able to send PS data on an uplink during said RAU procedure.

28. The method of claim 27, further comprising the step of executing a context transfer procedure with another support node currently serving said MS in said source cell.

29. The method of claim 28, further comprising the step of executing a packet data protocol (PDP) update procedure with a gateway support node (GGSN).

30. The method of claim 29, wherein said steps of executing a context transfer procedure and a PDP update procedure are executed after receiving said MS information request message but before executing said PDP update procedure.

31. The method of claim 28, wherein said step of executing a context transfer procedure is executed after receiving said MS information request message (18) but before sending said MS information response message (30).

32. Method for execution in a mobile communication system before execution of a routing area update (RAU) procedure associated with a handover of a mobile station (40) from a source cell to a target cell, comprising the steps of:
sending to a core network (CN) from a source base station (16) in said source cell a handover required message (14) having a mobile station identifier (IMSI), an identifier of at least one target cell routing area code (RAC) and a temporary logical link identity (TLLI),
sending to said source base station from said core network, in response to said handover required message, a handover command message (32) having a packet-temporary mobile subscriber identity (P-TMSI) for transfer to said mobile station in ciphered form over a radio interface between said source base station and said mobile station so that said mobile station is able to send packet-switched (PS) data on an uplink.

33. The method of claim 32, wherein said new packet-temporary mobile subscriber identity (P-TMSI) deciphered by said mobile station is for use in determining a temporary logical link identity for said mobile station to use in accessing packet-switched services of a support node (12) of the core network serving the target cell.

34. The method of claim 33, further comprising the step of executing, before said step of sending, a context transfer procedure between a support node (12) of the core network serving the target cell and a support node serving the source cell.

35. The method of claim 34, further comprising the step of executing an update context procedure with a gateway support node (GGSN).

36. The method of claim 32, further comprising the steps of:
receiving said handover required message from said source base station in a mobile switching center (10) of said core network and, in response thereto, sending a mobile station information request message (18) to a serving support node (12) of said target cell having said IMSI, said RAC and said TLLI,
receiving in said mobile switching center, an MS information response message (30) having a new packet-temporary mobile subscriber identity (P-TMSI), and
sending a handover command message (32) from said mobile switching center to said source base station having said P-TMSI for transfer to said mobile station in ciphered form over a radio interface between said source base station and said mobile station.

37. The method of claim 36, wherein said new packet-temporary mobile subscriber identity (P-TMSI) deciphered by said mobile station is for use in determining a temporary logical link identity for said mobile station to use in accessing packet-switched services of a support node (12) of the core network serving the target cell.

38. The method of claim 36, further comprising the step of executing, before said step of sending, a context transfer procedure between a support node (12) of the core network serving the target cell and a support node serving the source cell.

39. The method of claim 38, further comprising the step of executing an update context procedure with a gateway support node (GGSN).

40. Computer program stored on computer readable media for execution in said source base station and in said core network according to the steps of claim 32.

41. Mobile communication system having a source base station (16) in a source cell handing over a mobile station in said source cell to a target cell identified by said mobile station in a measurement report to said source base station, comprising:
means for sending to a core network (CN) from said source base station (16) in said source cell a handover required message (14) having a mobile station identifier (IMSI), a routing area code (RAC) associated with said source cell, and a temporary logical link identity (TLLI); and
means for sending to said source base station from said core network, in response to said handover required message, a handover command message (32) having a packet-temporary mobile subscriber identity (P-TMSI) for transfer to said mobile station in ciphered form over a radio interface between said source base station and said mobile station so that said mobile station is able to continue to send packet-switched data on an uplink during a routing area update (RAU) procedure associated with said handing over.

42. The system of claim 41, further comprising:
means in said source base station, responsive to said handover command message (32) from said core network, for sending a ciphered handover command message (42) to said mobile station.

43. The system of claim 42, further comprising:
means in said mobile station, responsive to said ciphered handover command message, for deciphering said ciphered handover command message and for determining a temporary logical link identity for said mobile station to use in addressing packet-switched services of a support node (12) of the core network serving the target cell.

44. The system of claim 41, further comprising means for executing a context transfer procedure between a support node (12) of the core network serving the target cell and a support node serving the source cell.

45. The system of claim 44, further comprising means for executing an update context procedure with a gateway support node (GGSN).

46. The system of claim 41, further comprising:
means for receiving said handover required message from said source base station in a mobile switching center (10) of said core network and, in response thereto, sending a mobile station information request message (18) to a serving support node (12) of said target cell having said IMSI, said RAC and said TLLI,
means for receiving in said mobile switching center, an MS information response message (30) having a new packet-temporary mobile subscriber identity (P-TMSI), and
means for sending a handover command message (32) from said mobile switching center to said source base station having said P-TMSI for transfer to said mobile station in ciphered form over a radio interface between said source base station and said mobile station.

47. The system of claim 46, wherein said new packet-temporary mobile subscriber identity (P-TMSI) deciphered by said mobile station is for use in determining a temporary logical link identity for said mobile station to use in accessing packet-switched services of a support node (12) of the core network serving the target cell.

48. The system of claim 46, further comprising means for executing a context transfer procedure between a support node (12) of the core network serving the target cell and a support node serving the source cell.

49. The system of claim 48, further comprising means for executing an update context procedure with a gateway support node (GGSN).
